(19) United States
(12) Patent Application Publication
(10) Pub. No.: US 2026/0121366 A1
(43) Pub. Date: Apr. 30, 2026

(54) ELECTRICAL CHARGING CONTACT BASE FOR CHARGING A VEHICLE

(71) Applicant: Conductix, Inc., Omaha, NE (US)

(72) Inventor: Jonathon D. Smith, Kalamazoo, MI (US)

(21) Appl. No.: 19/048,126

(22) Filed: Feb. 7, 2025

Related U.S. Application Data
(60) Provisional application No. 63/551,676, filed on Feb. 9, 2024.

(51) Int. Cl. H01R 41/00; B60L 53/16

(52) U.S. Cl. CPC H01R 41/00; B60L 53/16; H01R 2201/26

(57) ABSTRACT

An electrical contact base for charging a vehicle includes an insulating base having opposing side walls each with at least one slot, an insulating rail connected to the insulating base and having opposing side walls each with at least one slot, and first and second bus bars captured between the insulating base and the insulating rail. The first bus bar has a first contact plate with an opposing set of side tabs configured to be received and captured by one pair of slots of the insulating base and the insulating rail, and the second bus bar has a second contact plate with an opposing set of side tabs configured to be received and captured by the other pair of slots of the insulating base and the insulating rail.

### CROSS-REFERENCE TO RELATED APPLICATIONS

The present application claims the benefit under 35 U.S.C. § 119(e) of U.S. Provisional Application Ser. No. 63/551,676, filed Feb. 9, 2024, and titled “ELECTRICAL CHARGING CONTACT BASE FOR CHARGING A VEHICLE,” which is herein incorporated by reference in its entirety.

### BACKGROUND

Generally, a brush is an electrical contact which conducts current between stationary wires and moving parts.

### DRAWINGS

The Detailed Description is described with reference to the accompanying figures. The use of the same reference numbers in different instances in the description and the figures may indicate similar or identical items.

FIG. 1 is an isometric view illustrating an electrical contact base for charging a vehicle in accordance with example embodiments of the present disclosure.

FIG. 2 is an exploded isometric view of the electrical contact base illustrated in FIG. 1.

FIG. 3 is another exploded isometric view of the electrical contact base illustrated in FIG. 1.

### DETAILED DESCRIPTION

Aspects of the disclosure are described more fully hereinafter with reference to the accompanying drawings, which form a part hereof, and which show, by way of illustration, example features. The features can, however, be embodied in many different forms and should not be construed as limited to the combinations set forth herein; rather, these combinations are provided so that this disclosure will be thorough and complete, and will fully convey the scope. The following detailed description is, therefore, not to be taken in a limiting sense.

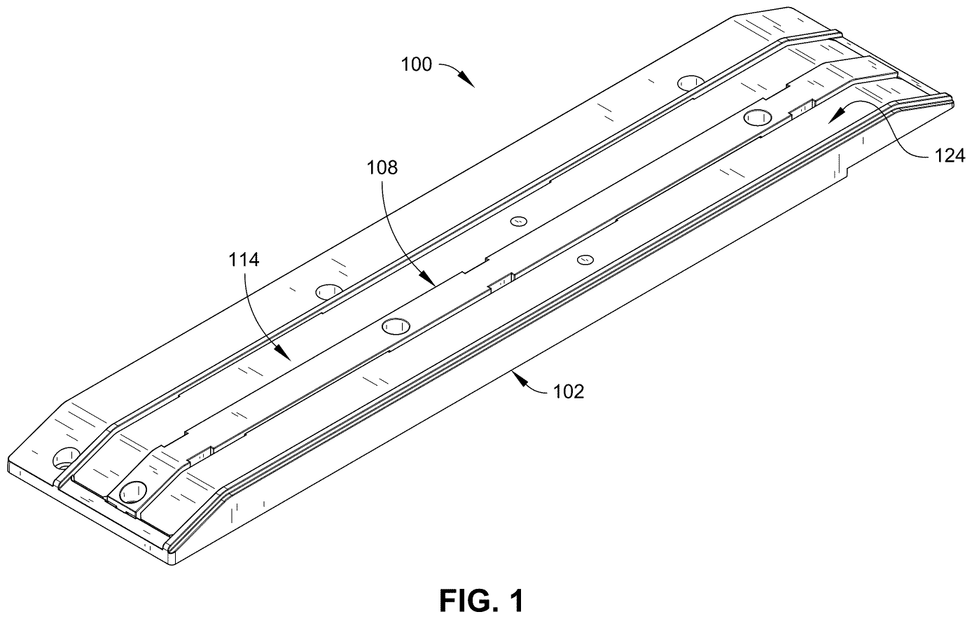

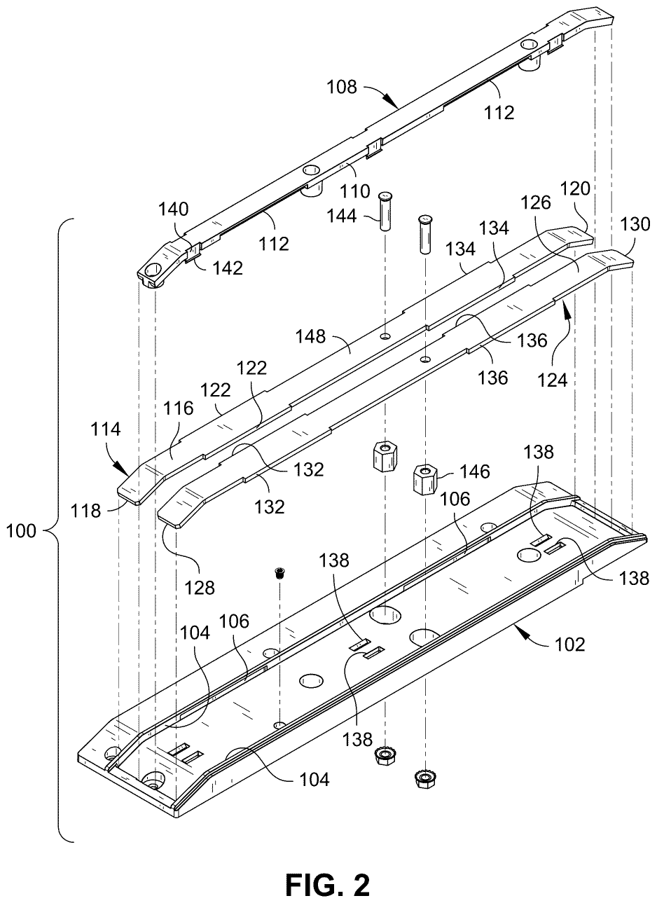

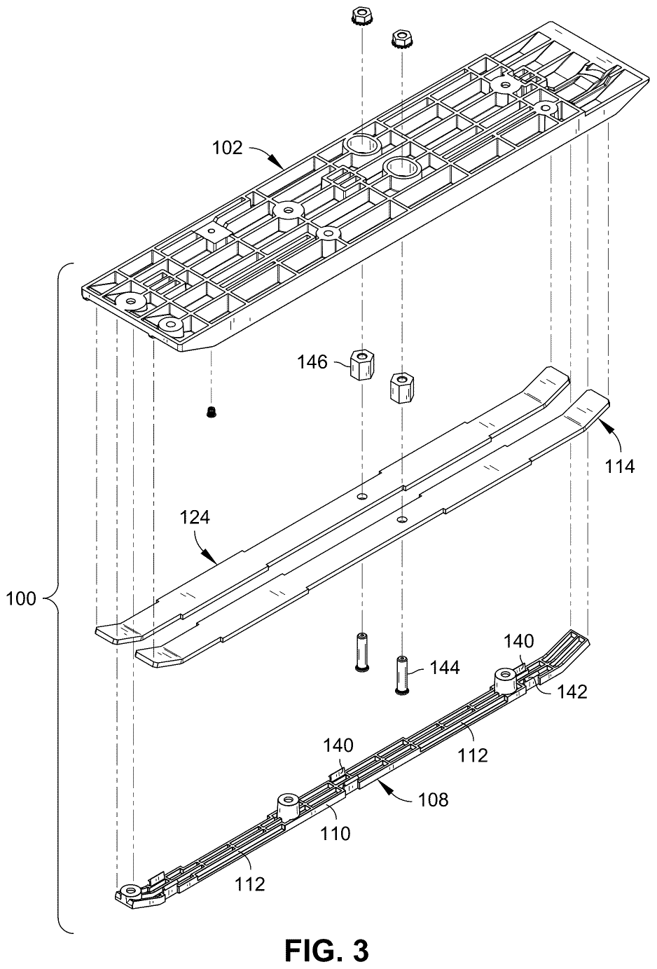

Referring generally to FIGS. 1 through 3, an electrical contact base 100 for charging a vehicle is described. The electrical contact base 100 is configured to contact one or more brushes for charging the vehicle. As described, an electrical contact base 100 can be used to charge a battery-powered vehicle by contacting the brushes to charge its battery, and then breaking contact after charging the battery. For example, an electrical contact base 100 can be generally ramp-shaped, and a charging brush assembly can have one or more brush contacts that are guided by the ramp shape of the electrical contact base 100 into contact with one or more battery charging contacts. In some embodiments, the battery-powered vehicle drives onto and/or over the brush assembly for charging, and then off of the brush assembly after charging. In this manner, the contacts of the electrical contact base 100 can be connected to a power source, such as a supply of electrical energy.

In general, it should be appreciated that the various embodiments of electrical contact bases 100 described herein may be arranged to deliver power to or receive power from a conducting surface. For example, in one arrangement, a charging brush assembly is coupled with a power source, and an electrical contact base 100 is coupled with a battery-powered vehicle. In this arrangement, the charging brush assembly delivers power to the electrical contact base 100 while the charging brush assembly is in electrical communication with the electrical contact base 100. In another arrangement of power delivery from a power source to a battery-powered vehicle, a charging brush assembly is coupled with a battery-powered vehicle, and an electrical contact base 100 is coupled with a power source. In this arrangement, the charging brush assembly receives electrical power from the electrical contact base 100 while the charging brush assembly is in electrical communication with the electrical contact base 100. It should also be noted that a battery-powered vehicle is provided by way of example and is not meant to limit the present disclosure. In embodiments, other energy storage devices may be used with the electrical contact bases 100 described herein, including, but not necessarily limited to a supercapacitor, which can be charged when the electrical contact base 100 is in contact with a power source.

The electrical contact base 100 includes a longitudinally extending insulating base 102 having opposing side walls 104 extending along opposing sides of the insulating base 102, where each one of the opposing side walls 104 of the insulating base 102 has at least one slot 106. The electrical contact base 100 also includes a longitudinally extending insulating rail 108 connected to the insulating base 102, where the insulating rail 108 has opposing side walls 110 extending along opposing sides of the insulating rail 108, and each one of the opposing side walls 110 of the insulating rail 108 has at least one slot 112.

In some embodiments, the insulating base 102 and/or the insulating rail 108 can be formed from electrically insulating material(s), such as a polymer insulator material. It should be noted that polymer insulators are provided by way of example and are not meant to limit the present disclosure. In other embodiments, the insulating base 102 and/or the insulating rail 108 can be formed from various other insulating materials. As described, the insulating base 102 and the insulating rail 108 can be connected together by a snap-fit connection. For example, the insulating base 102 can include cavities 138 into which cantilever arms 140 protruding from the insulating rail 108 with interlocking features such as hooks 142 can be inserted and used to connect the insulating base 102 and the insulating rail 108 together. In this example, an interlocking hook 142 snaps into place in a corresponding cavity 138. However, it should be noted that a cantilever snap-fit is provided by way of example and is not meant to limit the present disclosure. In other embodiments, different connections between the insulating base 102 and the insulating rail 108 can be used, including other snap fit connections, such as annular snap-fit connections, torsional snap-fit connections, and so forth. In some embodiments, the electrical contact base 100 can be constructed without the use of fasteners, such as screws, rivets, and so forth. In this manner, separate mechanical fastening hardware is not necessarily used during assembly of the insulating base 102 and the insulating rail 108. For example, the insulating base 102 and the insulating rail 108 are held together by a snap fit and thereby capture conductors. The electrical contact base 100 can be held together using the snap fit features until, for example, it is installed for end use, which may be performed using fasteners, such as screws. Such mounting hardware is then insulated by the insulating base 102 and the insulating rail 108.

The electrical contact base 100 includes a longitudinally extending first bus bar 114 captured between the insulating base 102 and the insulating rail 108. The first bus bar 114 has a first contact plate 116 and an integrally connected first end tab 118 for guiding a brush onto the electrical contact base 100 and into contact with the first contact plate 116. In some embodiments, the first end tab 118 defines an incline for guiding the brush onto the electrical contact base 100 and into contact with the first contact plate 116. In some embodiments, the first bus bar 114 includes another end tab 120 integrally connected to the first contact plate 116 opposite the first end tab 118 for guiding a brush onto the electrical contact base 100 and into contact with the first contact plate 116. The additional end tab 120 can also define an incline for guiding the brush onto the electrical contact base 100 and into contact with the first contact plate 116. As described, the first contact plate 116 has an opposing set of side tabs 122 extending generally perpendicular to the longitudinal extension of the first bus bar 114, and the opposing set of side tabs 122 of the first bus bar 114 is configured to be received and captured by at least one slot 106 of the insulating base 102 and at least one slot 112 of the insulating rail 108.

The electrical contact base 100 can also include a longitudinally extending second bus bar 124 captured between the insulating base 102 and the insulating rail 108. The second bus bar 124 has a second contact plate 126 and an integrally connected second end tab 128 for guiding a brush onto the electrical contact base 100 and into contact with the second contact plate 126. In some embodiments, the second end tab 128 defines an incline for guiding the brush onto the electrical contact base 100 and into contact with the second contact plate 126. In some embodiments, the second bus bar 124 includes another end tab 130 integrally connected to the second contact plate 126 opposite the second end tab 128 for guiding a brush onto the electrical contact base 100 and into contact with the second contact plate 126. The additional end tab 130 can also define an incline for guiding the brush onto the electrical contact base 100 and into contact with the second contact plate 126. As described, the second contact plate 126 has an opposing set of side tabs 132 extending generally perpendicular to the longitudinal extension of the second bus bar 124, and the opposing set of side tabs 132 of the second bus bar 124 is configured to be received and captured by at least one other slot 106 of the insulating base 102 and at least one other slot 112 of the insulating rail 108.

In some embodiments, a bus bar 114 and/or 124 can have an electrical connector for connecting to a source of electrical power or another connection for transferring electrical energy. For instance, a copper tube with an internal thread can be joined to a contact plate 116 and/or 126 via rotational friction welding, soldering, brazing, and so forth. In another example, a press-in stud 144 can be installed into the contact plate 116 and/or 126, and a free-floating tube 146 can be installed over the press-in stud. In this example, the free-floating tube provides the electrical connection to the contact plate 116 and/or 126, and the press-in stud allows clamping force to be developed between the connection points. In a further example, a capacitive discharge welded stud can be welded to the bottom of the contact plate 116 and/or 126, and a free-floating tube can be fastened as described above. In a still further example, a leg of material continuous with the contact plate 116 and/or 126 can be bent into a U-shape and have a threaded hole near its end, providing a connection point. In another example, a separate U-shaped conductive piece with a threaded hole can be linear friction welded, soldered, or brazed onto the bottom of the contact plate 116 and/or 126, providing a connection point. The contact plate 116 and/or 126 can also define a threaded aperture and/or another connection point for receiving a conductive connection, such as a countersunk screw connection.

It should be noted that two bus bars 114 and 124 are provided by way of example and are not meant to limit the present disclosure. In other embodiments, more or fewer than two bus bars 114 and 124 may be included with an electrical contact base 100. The first and/or second end tabs 118, 120, 128, and/or 130 of the bus bars 114 and 124 can be free of (e.g., not captured by) the insulating base 102 and the insulating rail 108. In this manner, the ends can float to allow for manufacturing deviations in the insulating base 102 and/or the insulating rail 108. In some embodiments, the end tabs 118, 120, 128, and/or 130 can be shorter than the receiving openings formed for the tabs in the insulating base 102. In this manner, the end tabs 118, 120, 128, and/or 130 may be less likely to interfere with automated assembly processes, such as robotic assembly.

In some embodiments, one or more of the opposing side walls 104 of the insulating base 102 has at least a second slot 106 and one or more of the opposing side walls 110 of the insulating rail 108 has at least a second slot 112. In this example, the first bus bar 114 and/or the second bus bar 124 can have an opposing second set of side tabs 134 and/or 136 extending generally perpendicular to the longitudinal extension of the first bus bar 114 or the second bus bar 124, where the opposing second set of side tabs 134 and/or 136 is configured to be received and captured by the second slot 106 of the insulating base 102 and the second slot 112 of the insulating rail 108. As described, the opposing set of side tabs 122 and/or 132 and the opposing second set of side tabs 134 and/or 136 of the first bus bar 114 and/or the second bus bar 124 can be symmetrically arranged, so that, in combination with the slots 106 and 112 of the insulating base 102 and the insulating rail 108, the first bus bar 114 and/or the second bus bar 124 can be reversibly captured (e.g., the bus bars 114 and/or 124 can interface with the slots in the insulating base 102 and the insulating rail 108 in orientations rotated one hundred and 180 degrees apart from one another).

In some embodiments, the opposing side walls 104 of the insulating base 102 and the opposing side walls 104 of the insulating rail 108 protrude above a top surface 148 of the first contact plate 116 of the first bus bar 114 and/or the second contact plate 126 of the second bus bar 124. This arrangement can prevent incidental contact between the first contact plate 116 and the second contact plate 126 and items in the vicinity of the electrical contact base 100. For example, if a wrench falls onto the electrical contact base 100, the protruding side walls can prevent the wrench from completing a circuit and electrically shorting adjacent bus bars 114 and 124.

Although the subject matter has been described in language specific to structural features and/or process operations, it is to be understood that the subject matter defined in the appended claims is not necessarily limited to the specific features or acts described above. Rather, the specific features and acts described above are disclosed as example forms of implementing the claims.

What is claimed is:

1. An electrical contact base for charging a vehicle, the electrical contact base configured to contact a brush for charging the vehicle, the electrical contact base comprising:
a longitudinally extending insulating base having opposing side walls extending along opposing sides of the insulating base, each one of the opposing side walls of the insulating base having at least one slot;
a longitudinally extending insulating rail connected to the insulating base, the insulating rail having opposing side walls extending along opposing sides of the insulating rail, each one of the opposing side walls of the insulating rail having at least one slot;
a longitudinally extending first bus bar captured between the insulating base and the insulating rail, the first bus bar having a first contact plate and an integrally connected first end tab for guiding a brush onto the electrical contact base and into contact with the first contact plate, the first contact plate having an opposing set of side tabs extending generally perpendicular to the longitudinal extension of the first bus bar, the opposing set of side tabs of the first bus bar configured to be received and captured by at least one slot of the insulating base and at least one slot of the insulating rail; and
a longitudinally extending second bus bar captured between the insulating base and the insulating rail, the second bus bar having a second contact plate and an integrally connected second end tab for guiding a brush onto the electrical contact base and into contact with the second contact plate, the second contact plate having an opposing set of side tabs extending generally perpendicular to the longitudinal extension of the second bus bar, the opposing set of side tabs of the second bus bar configured to be received and captured by at least one other slot of the insulating base and at least one other slot of the insulating rail.

2. The electrical contact base as recited in claim 1, wherein one of the opposing side walls of the insulating base has at least a second slot, one of the opposing side walls of the insulating rail has at least a second slot, and at least one of the first bus bar or the second bus bar has an opposing second set of side tabs extending generally perpendicular to the longitudinal extension of the first bus bar or the second bus bar, the opposing second set of side tabs configured to be received and captured by the second slot of the insulating base and the second slot of the insulating rail.

3. The electrical contact base as recited in claim 1, wherein at least one of the first end tab or the second end tab defines an incline for guiding the brush onto the electrical contact base and into contact with the at least one of the first contact plate or the second contact plate, respectively.

4. The electrical contact base as recited in claim 1, wherein the insulating base and the insulating rail are formed of polymer insulator material.

5. The electrical contact base as recited in claim 1, wherein the insulating base and the insulating rail are connected by a snap-fit connection.

6. The electrical contact base as recited in claim 1, wherein at least one of the first bus bar or the second bus bar includes a third end tab integrally connected to the at least one of the first contact plate or the second contact plate, respectively, opposite the at least one of the first end tab or the second end tab for guiding the brush onto the electrical contact base and into contact with the at least one of the first contact plate or the second contact plate, respectively.

7. The electrical contact base as recited in claim 1, wherein the opposing side walls of the insulating base and the opposing side walls of the insulating rail protrude above a top surface of at least one of the first contact plate of the first bus bar or the second contact plate of the second bus bar.

8. An electrical contact base for charging a vehicle, the electrical contact base configured to contact a brush for charging the vehicle, the electrical contact base comprising:
a longitudinally extending insulating base having opposing side walls extending along opposing sides of the insulating base, at least one of the opposing side walls of the insulating base having a slot;
a longitudinally extending insulating rail connected to the insulating base, the insulating rail having opposing side walls extending along opposing sides of the insulating rail, at least one of the opposing side walls of the insulating rail having a slot; and
a longitudinally extending bus bar captured between the insulating base and the insulating rail, the bus bar having a contact plate for receiving a brush into contact with the contact plate, the contact plate having an opposing set of side tabs extending generally perpendicular to the longitudinal extension of the bus bar, the opposing set of side tabs of the bus bar configured to be received and captured by the slot of the insulating base and the slot of the insulating rail.

9. The electrical contact base as recited in claim 8, wherein the bus bar includes an integrally connected end tab for guiding a brush onto the electrical contact base and into contact with the contact plate.

10. The electrical contact base as recited in claim 9, wherein the end tab defines an incline for guiding the brush onto the electrical contact base and into contact with the contact plate.

11. The electrical contact base as recited in claim 9, wherein the bus bar includes a second end tab integrally connected to the contact plate opposite the first end tab for guiding the brush onto the electrical contact base and into contact with the contact plate.

12. The electrical contact base as recited in claim 8, further comprising a longitudinally extending second bus bar captured between the insulating base and the insulating rail, the second bus bar having a second contact plate for receiving a brush into contact with the second contact plate, the second contact plate having an opposing set of side tabs extending generally perpendicular to the longitudinal extension of the second bus bar, the opposing set of side tabs of the second bus bar configured to be received and captured by at least one other slot of the insulating base and at least one other slot of the insulating rail.

13. The electrical contact base as recited in claim 12, wherein the second bus bar includes an integrally connected second end tab for guiding a brush onto the electrical contact base and into contact with the second contact plate.

14. The electrical contact base as recited in claim 8, wherein one of the opposing side walls of the insulating base has at least a second slot, one of the opposing side walls of the insulating rail has at least a second slot, and the bus bar has an opposing second set of side tabs extending generally perpendicular to the longitudinal extension of the bus bar, the opposing second set of side tabs configured to be received and captured by the second slot of the insulating base and the second slot of the insulating rail.

15. The electrical contact base as recited in claim 8, wherein the insulating base and the insulating rail are formed of polymer insulator material.

16. The electrical contact base as recited in claim 8, wherein the insulating base and the insulating rail are connected by a snap-fit connection.

17. The electrical contact base as recited in claim 8, wherein the opposing side walls of the insulating base and the opposing side walls of the insulating rail protrude above a top surface of at least one of the first contact plate of the first bus bar or the second contact plate of the second bus bar.

18. An electrical contact base for charging a vehicle, the electrical contact base configured to contact a brush for charging the vehicle, the electrical contact base comprising:
a longitudinally extending insulating base having opposing side walls extending along opposing sides of the insulating base, each one of the opposing side walls of the insulating base having at least one slot;
a longitudinally extending insulating rail connected to the insulating base, the insulating rail having opposing side walls extending along opposing sides of the insulating rail, each one of the opposing side walls of the insulating rail having at least one slot;
a longitudinally extending first bus bar captured between the insulating base and the insulating rail, the first bus bar having a first contact plate and an integrally connected first end tab, the first end tab defining an incline for guiding a brush onto the electrical contact base and into contact with the first contact plate, the first contact plate having an opposing set of side tabs extending generally perpendicular to the longitudinal extension of the first bus bar, the opposing set of side tabs of the first bus bar configured to be received and captured by at least one slot of the insulating base and at least one slot of the insulating rail; and
a longitudinally extending second bus bar captured between the insulating base and the insulating rail, the second bus bar having a second contact plate and an integrally connected second end tab, the second end tab defining an incline for guiding a brush onto the electrical contact base and into contact with the second contact plate, the second contact plate having an opposing set of side tabs extending generally perpendicular to the longitudinal extension of the second bus bar, the opposing set of side tabs of the second bus bar configured to be received and captured by at least one other slot of the insulating base and at least one other slot of the insulating rail, the opposing side walls of the insulating base and the opposing side walls of the insulating rail protruding above a top surface of at least one of the first contact plate of the first bus bar or the second contact plate of the second bus bar.

19. The electrical contact base as recited in claim 18, wherein one of the opposing side walls of the insulating base has at least a second slot, one of the opposing side walls of the insulating rail has at least a second slot, and at least one of the first bus bar or the second bus bar has an opposing second set of side tabs extending generally perpendicular to the longitudinal extension of the first bus bar or the second bus bar, the opposing second set of side tabs configured to be received and captured by the second slot of the insulating base and the second slot of the insulating rail.

20. The electrical contact base as recited in claim 18, wherein the insulating base and the insulating rail are connected by a snap-fit connection.
